(19) United States
(12) Patent Application Publication
(10) Pub. No.: US 2003/0083599 A1
(43) Pub. Date: May 1, 2003

(54) Acoustic band vibration massage for muscle relaxation: method and device

(76) Inventor: Zeev Kitov, Rockville, MD (US)

Correspondence Address: NATH & ASSOCIATES PLLC, Sixth Floor, 1030 Fifteenth Street, N.W., Washington, DC, 20005, US

(21) Appl. No.: 09/985,125

(22) Filed: Nov. 1, 2001

(51) Int. Cl. A61H 7/00

(52) U.S. Cl. 601/84

(57) ABSTRACT

A device and a method of vibratory massage. The device produces acoustic vibrations of variable frequency in a frequency range of 250-350 Hz to stimulate fast-adapting mechano-receptors in muscles, tendons and joints, that have a peak of vibrating sensitivity at these frequencies. The device has a flexible vibrating pad mounted on a housing. The housing contains a mechanical vibrator and an electronic circuit and power supply that generate the low frequencies and cause the vibrations of the mechanical vibrator. According to the method, a flexible vibrating pad is applied to a tissue in one of two ways, tangential or normal. To maximize the afferent input to the Central Nervous System, a vibratory stimulation is applied not only to the pain afflicted area, but also to symmetrical areas on the contralateral side of the body and similar zones according to the anterior-posterior symmetry. To prevent habituation, the frequency of the applied signal is either frequency modulated, or changes randomly in a predetermined frequency band.

### FIELD OF THE INVENTION

This invention relates to a device for vibratory massage and the method for using the same, and more particularly to a device operating in the lower portion of the acoustic band, that can be used to provide a stimulation of the muscles, tendons and joints.

### BACKGROUND OF THE INVENTION

Vibrating massage devices are used in sports and physical therapy applications where the athletes/patients need to achieve muscle relaxation before and after a training session. Two widely used modalities available today for this goal are Ultrasound equipment, and vibration massage devices.

An Ultrasound equipment produces heat in deep muscle tissues. This equipment is cumbersome and requires application of substantial power, more than 1 W/cm². It may also cause burns when used by inexperienced people, and thus requires professional supervision.

A vibration massager produces a low frequency periodical movement of muscle tissues, which increases blood flow. This method still requires substantial power and is rather ineffective in achieving muscle relaxation and alleviation of pain.

Thus, there is a need for an effective means for relaxing and healing muscles, tendons and joints, that does not require professional supervision and that presents no risk of injury in case of malfunction or inconsiderate use.

There is also a need for a hand-held, low-power consumption device for massage that provides a convenient and effective alternative to professional but cumbersome equipment.

### SUMMARY OF THE INVENTION

The present invention overcomes the deficiencies of the prior art by providing both a method and a device for vibratory massage, that are effective, inexpensive and safe.

The advantages of the present invention are realized by the use of a low portion of acoustic band frequencies (i.e. sound frequencies), between 250 Hz and 350 Hz, for vibration massage.

To prevent habituation, the sound frequency is periodically changed, randomly or by frequency modulation. To reduce acoustic losses at the interface with a soft tissue, a flexible vibrating pad with a specific degree of flexibility is used as a vibration carrier.

The pad can be applied to the tissue in one of two ways, tangential to the surface of the tissue or normal to the surface of the tissue.

Additionally, to maximize an afferent stimulation input to the Central Nervous System (CNS), the stimulation is to be applied not only to the pain afflicted area, but to symmetrical areas on the contralateral side of the body, and to similar zones according to the anterior-posterior symmetry of the body.

According to one embodiment of the present invention a method of vibration massage is carried out by using a hand-held device having a flexible vibrating pad attached to, and extending beyond the boundaries of an enclosure, that transmits the vibration stimulus by simple contact with the tissue. The presently preferred frequencies of stimulation are between 250 Hz and 350 Hz.

The vibrating pad is driven by a vibration element which can comprise a piezo-bender or an eccentric-weight rotating element, driven by an electrical circuit that provides a modulated or randomly changing frequency.

The method and the device of the invention provide an effective tool for massage, while substantially reducing the required power. Instead of directly moving the bulk of muscle tissue by the vibrator, the vibration is used as a stimulant for the fast adapting mechano-receptors in the muscles, tendons and joints. To make such stimulation efficient, apparatus and method according to the present invention use a lower portion of acoustic frequencies, which in a preferred embodiment is in the range of 250-350 Hz, these frequencies being in the resonance range of fast adapting mechano-receptors such as Pacinian fibers.

These mechano-receptors are sensitive to the dynamic components, i.e. rapid changes, of touch and pressure. Being stimulated, they send afferent signals to the CNS, simulating a pattern of dynamic changes in touch and pressure. This triggers an efferent neural response of adaptation to new conditions causing reduction in the muscle and vascular tone and, as a rule, increasing micro-circulation.

Since the mechano-receptors are highly sensitive to minor mechanical displacements of the skin, the amount of energy required to stimulate them is much smaller than that necessary for direct massage, i.e. for moving a bulk of muscle tissue.

Therefore, the acoustic power spent by a method according to the present invention is substantially lower than the power used by Ultrasound equipment or the known vibration massage devices used for the same purpose.

Furthermore, these frequencies being perceivable by the human ear, can affect the CNS though the hearing path, forming a biofeedback loop, which can produce additional muscle relaxation.

In order to prevent habituation, the temporal pattern of the sound frequency is periodically changed. This can be done either by using frequency modulation, i.e. periodically changing the audio frequency by a source of infra-sound frequency, typical for brain rhythms, in the range 1-20 Hz, or by using waves with frequencies randomly changing inside a predetermined window of 250-350 Hz.

In a specific feature of the present invention, to indicate the end of stimulation and to terminate a possible biofeedback process, a short signal with audible frequency beyond the range of sensitivity of mechano-receptors, should be applied to the stimulation spot. The signal could last some seconds and may comprise a single modulated, unmodulated, or multiple frequencies.

A comprehensive protocol is recommended according to a presently preferred method according to the present invention, which includes stimulation of mechano-receptors by frequencies in the range of 250-350 Hz, followed by a short application of a signal comprising frequencies above 350 Hz.

It is obvious that the amplitude of the pad oscillation should be maximized, in order to maximize efficiency.

The vibrating pad can be applied to the tissue in one of two ways, tangential (flat) or normal (standing). In the case of tangential application a large area of the muscle is stimulated. In the case of normal application of the pad, a sharp spatial gradient of vibration is formed across the affected area.

Additionally, to maximize the afferent input to the CNS, a protocol is proposed, according to which the stimulation is to be applied not only to the pain afflicted area, but to the symmetrical areas of the body lying at the same height, i.e. on the contralateral side of the body, according to the sagittal symmetry, and on the opposite side of the body, according to the anterior-posterior symmetry. Such approach is based on the symmetrical picture of dermatomes, i.e. segmental innervation of the skin.

### BRIEF DESCRIPTION OF THE DRAWINGS

FIG. 1 is a top plan view of a massage device in accordance with the present invention.

FIG. 2 is a general elevational cross-sectional view of a massage device along line 2-2 of FIG. 1, in accordance with the present invention.

FIG. 3 is an enlarged, elevational cross-sectional view of a vibration element and attached vibrating pad of the massage device in accordance with a first embodiment of the present invention.

FIG. 4 is an enlarged, elevational cross-sectional view of a vibration element and attached vibrating pad of the massage device in accordance with a second embodiment of the present invention.

FIG. 5 is an electrical schematic block diagram of an electrical circuit that drives the vibration element according to the first and second embodiments of the present invention.

FIG. 6 is an electrical schematic block diagram of an alternate electrical circuit that drives the vibration element according to the first and second embodiments of the present invention.

FIG. 7 is an enlarged elevational view, partly in cross section and partly schematic of a vibration element and attached vibrating pad of the massage device in accordance with a third embodiment of the present invention.

FIG. 8 is an electrical schematic block diagram of an electrical circuit that drives the vibration element according to the third embodiment of the present invention.

FIG. 9a is a schematic front elevational view of a human body showing the use of a massage device in accordance with the present invention.

FIG. 9b is a schematic side elevational view of a human body showing the use of a massage device in accordance with the present invention.

### DETAILED DESCRIPTION OF THE PREFERRED EMBODIMENT

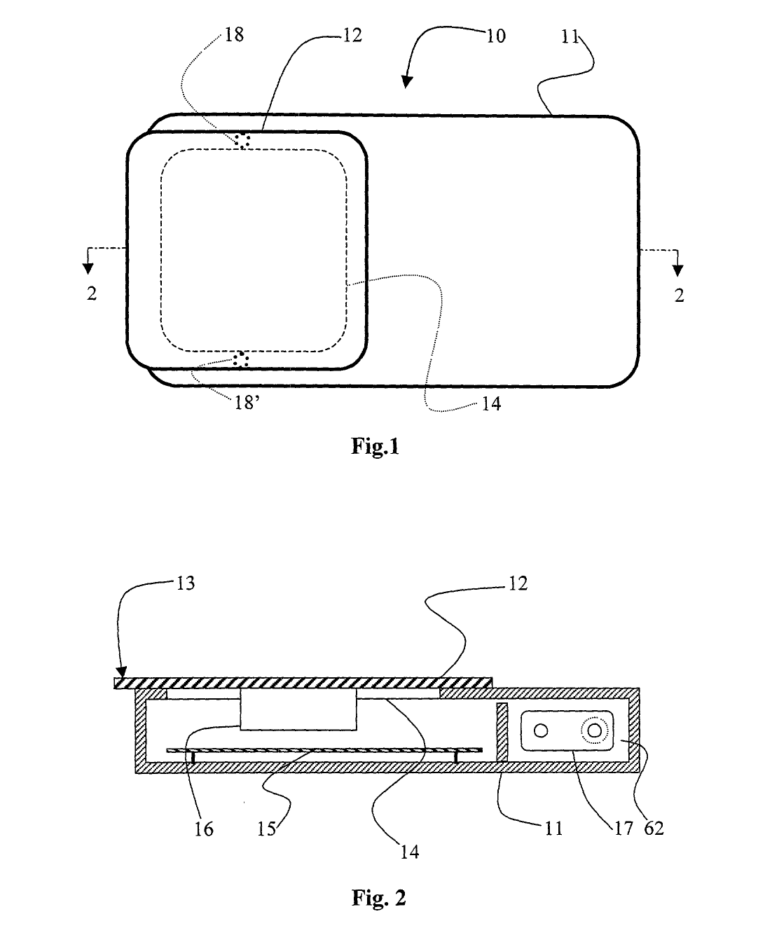

With reference now to the figures wherein like elements have the same number throughout the several views, and in particular with reference to FIG. 1 and FIG. 2, there is depicted a vibratory massage device 10 according to a preferred embodiment of the present invention.

Vibratory massage device 10 comprises an enclosure 11 and a vibrating pad 12, which has a portion 13 thereof that extends beyond the boundaries of enclosure 11 for normal (vertical) application to a tissue.

Enclosure 11 has a circular or rectangle opening 14 covered by vibrating pad 12. Vibrating pad 12 is driven by a vibration element 16 attached to vibrating pad 12 in the center thereof. Vibrating pad 12 is attached or mounted with glue, other adhesive or by a physical attachment such as a rivet, in at least two points such as 18 and 18′, to enclosure 11 over the area of opening 14. Vibration element 16 is driven by electrical pulses and causes pad 12 to oscillate. The surface area of vibrating pad 12 is slightly larger than that of opening 14 and thus slightly overlaps opening 14. Vibrating pad 12 thus has the maximum freedom for oscillation as a result of its mounting means and location.

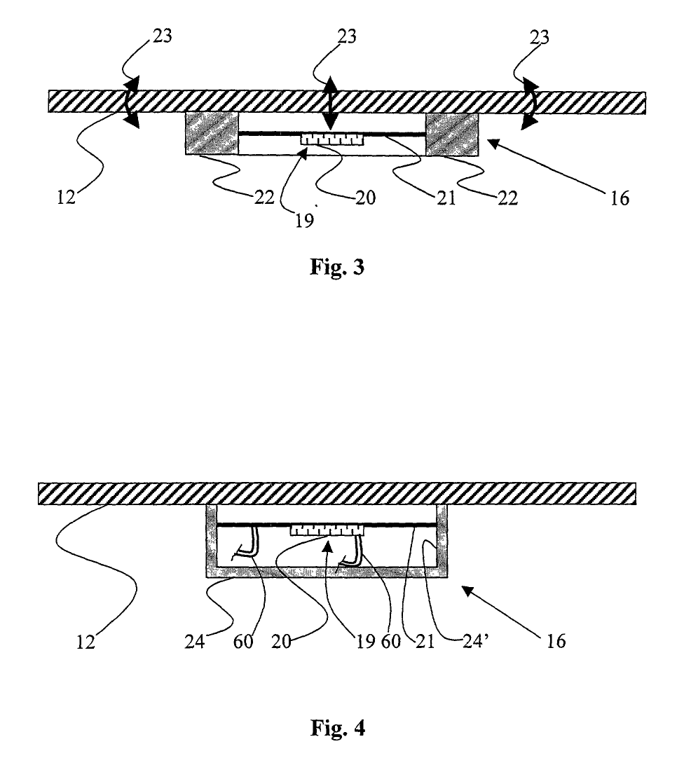

In a first embodiment of a means for vibrating vibration pad 12, shown in FIG. 3, a piezoelectric transducer 19, or bender, comprises a piezo-ceramic disk 20 attached by an adhesive to a larger diameter metal disk 21. Disk 21 is circumferentially encapsulated into a plastic circular edge ring 22 which, in turn, is attached to vibrating pad 12 by an attachment means such as an adhesive or a physical member such as a rivet.

Both piezo-ceramic disk 20 and metal disk 21 are electrically connected to an electronic control circuit board 15 by electrical wires 60 (as shown in FIG. 4), one of which is physically attached to disk 20 and one to disk 21, such as by being soldered thereon. Electronic control circuit board 15 is powered by an electrical battery 17 located in a battery compartment 62 of enclosure 11 (as shown on FIG. 2).

When electrical pulses are applied to the piezoelectric transducer, they cause oscillations of vibrating pad 12 in the directions as shown by double-headed arrows 23 on FIG. 3.

When in use, pad 12 is lightly pressed against the surface of a body and causes periodical displacement of the skin. To maximize acoustic output and to prevent losses at the interface between vibrating pad 12 and enclosure 11, vibrating pad 12 is made of a flexible material having a Flexural modulus of at least one order of magnitude lower than that of enclosure 11, and the thickness of vibrating pad 12 is at most half that of enclosure 11.

In another embodiment of the present invention, vibration element 16, as shown in FIG. 4, is encapsulated in a resonance box 24 having an inner wall 24′. Referring again to FIG. 4, piezoelectric transducer 19, comprising a piezo-ceramic disk 20 attached to a larger diameter metal disk 21, is circumferentially attached to inner wall 24′ of cylindrical resonance box 24. The top of resonance box 24 is circumferentially attached to vibrating pad 12 with means such as an adhesive, thereby hermetically sealing the internal volume of resonance box 24.

To maximize acoustic output and to prevent losses at the interface between vibrating pad 12 and enclosure 11, vibrating pad 12 is again manufactured from a flexible material having a Flexural modulus of at least one order of magnitude lower than that of enclosure 11 and of the same order as the Flexural modulus of resonance box 24, and the thickness of vibrating pad 12 is again at most half that of enclosure 11.

Massage device 10 of the present invention can be easily manufactured and assembled using “off the shelf” parts. Enclosure 11 is a box made of ABS polymer, such as enclosure model HML-9VB, available from PacTec Corp., that comes with a battery compartment and a circuit board compartment. The typical dimensions of enclosure 11 are: 2.57″×4.60″×1.00″. Vibrating pad 12 is a rectangular, 0.075″ thick, piece of low density polyethylene (LDPE), which covers approximately half of the top surface of enclosure 11, i.e. which dimensions are approximately: 2.5″×2.5″.

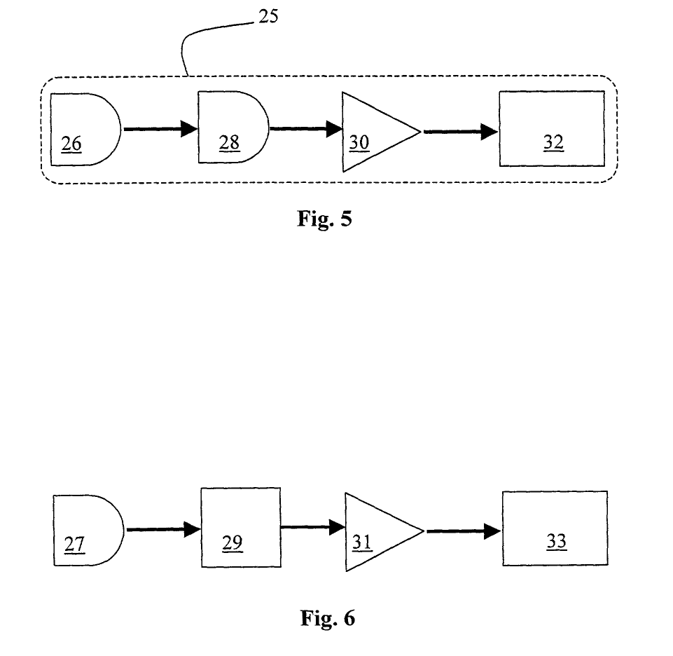

A block-diagram of an electronic circuit 25, driving vibration elements 16, is shown in FIG. 5. Electronic circuit 25 is comprised of a first electronic oscillator 26 connected to a second electronic oscillator 28. First electronic oscillator 26 generates a sinusoidal wave with a frequency in the range 1-20 Hz and second electronic oscillator 28 generates a sinusoidal wave with a frequency of about 300 Hz. First oscillator 26 provides continuous control of the frequency generated by second oscillator 28, so that the wave of second oscillator 28 is frequency modulated by the wave of first oscillator 26. The resulting wave appearing at the output of second oscillator 28 has a frequency in the range 250-350 Hz. An amplifier 30 is connected to the output of second oscillator 28 and amplifies the resulting wave. The output of amplifier 30 is connected to a vibration element electrical input 32.

Another way to obtain a changing frequency is shown in FIG. 6. A random pulse, and therefore random frequency, source 27 is connected to a band-pass filter 29 having a passing band of 250-350 Hz which filters the output of random frequency source 27. The output from filter 29 is connected to an amplifier 31 which amplifies the resulting signal. The output from amplifier 31 is connected to a vibration element electrical input 33. The output wave produced by filter 29 has a randomly changing frequency wave inside the above-mentioned band of 250-350 Hz.

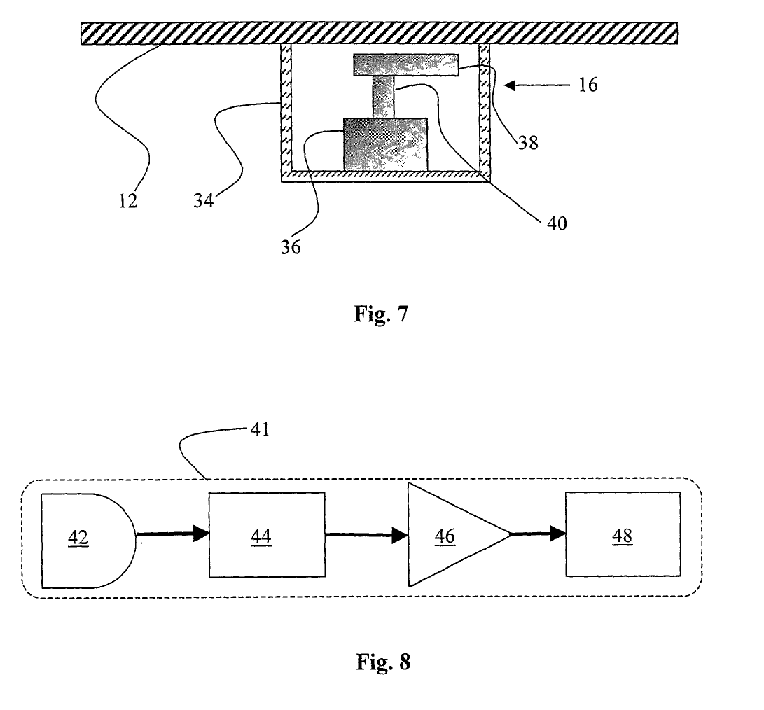

In another embodiment of the invention vibration element 16 is a mechanical vibrator such as a rotating eccentric weight device, as shown in FIG. 7. Vibrating pad 12 is attached, with an adhesive or other attaching means, to enclosure 11, which in turn is firmly attached to an enclosure 34 of a DC motor 36, with an adhesive or other attaching means. Enclosure 34 is attached to vibrating pad 12 with an adhesive or other attaching means. An eccentric load 38 is attached to motor axis 40. Rotation of motor 36 results in the oscillation of pad 12 with a frequency equal to the angular speed of rotation.

To generate a periodically changing frequency, the speed of rotation of motor 36 is controlled by an electronic circuit which varies the supply voltage in accordance to the desired speed and frequency of motor 36. As shown in FIG. 8, an electronic circuit 41 is comprised of an oscillator 42 which generates a sinusoidal wave with a frequency in the range 1-20 Hz. The output of oscillator 42 is connected to a converter 44 that provides a pulse-width modulation (PWM) pattern by converter 44. An amplifier 46, connected to the output of converter 44, amplifies the power of the resulting PWM pulses, and the output of amplifier 46 is connected to a DC motor electrical input 48.

The invented device is to be applied to the skin of human subjects, which can carry substantial electrostatic charge. Special measures are necessary for Electrostatic Discharge (ESD) protection of the device electronics. For that purpose the upper side of the vibrating pdd can be coated with an anti-static dissipative, or conductive layer of material. The conductive material layer can be electrically connected to a ground wire of the electronic control circuit board. Both piezo-electric element and electrical circuit can have a conventional ESD protection circuitry, to bypass any electrostatic charge.

The amplitude of oscillation of vibrating pad 12 should be maximized, in order to maximize efficiency. The amplitude of oscillation of vibrating pad 12 is maximized by the attachment means, between vibrating pad 12 and enclosure 11, being a flexible glue such as a commercially available hot melt adhesive.

The vibrating pad can be applied to the tissue in one of two ways, tangential (flat) or normal (standing). In the case of tangential application a large area of the muscle is stimulated. In the case of normal application of the pad, a sharp spatial gradient of vibration is formed across the affected area.

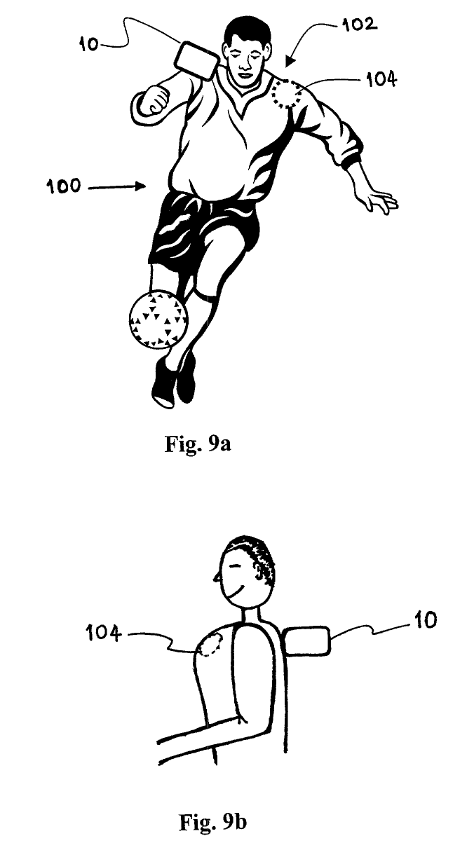

Additionally, to maximize the afferent input to the CNS, a protocol is proposed, according to which the stimulation is to be applied not only to the, pain afflicted area, but to the symmetrical areas of the body lying at the same height, as shown in FIG. 9a and FIG. 9b, i.e. on the contralateral side of the body, according to the sagittal symmetry, and on the opposite side of the body, according to the anterior-posterior symmetry. Such approach is based on the symmetrical picture of dermatomes, i.e. segmental innervation of the skin.

In use, as shown in FIG. 9a and FIG. 9b, a human body 100 contains living body tissue, such as shoulder 102. Fast adapting mechano-receptors are contained in shoulder 102 and device 10 is applied to shoulder 102 at a same height as a pain afflicted area 104 to a skin area over the afflicted area, to a contralateral side and to an opposite side of the body with respect to sagittal and anterior-posterior symmetry.

Although only a few exemplary embodiments of the present invention have been described above, it will be appreciated by those skilled in the art that many changes may be made to these embodiments without departing from the principles and the spirit of the invention.

I claim:

1. A vibratory massage device comprising
a vibrating pad;
a mechanical vibration element; and
an electronic control circuit wherein said vibrating pad is mechanically connected to said mechanical vibration element, and said mechanical vibration element is driven by said electronic control circuit to oscillate with a variable frequency within a frequency range of 250-350 Hz.

2. The vibratory massage device as claimed in claim 1 wherein said vibratory massage device further comprises a primary enclosure defining an enclosed volume and having an opening, said opening having a surface and an edge portion.

3. The vibratory massage device as claimed in claim 2 wherein said vibrating pad has an internal face and an external face, and a surface slightly larger than the surface of said opening, said vibrating pad being positioned on top of said opening and overlapping the edge portion of said opening.

4. The vibratory massage device as claimed in claim 3 wherein said vibrating pad is attached to said primary en closure in at least two points of the edge portion of the opening.

5. The vibratory massage device as claimed in claim 4 wherein said mechanical vibration element comprises a piezoelectric transducer comprising a metal disk and a piezo-ceramic disk, said metal disk having a top side and a bottom side, said piezo-ceramic disk having a smaller diameter than the diameter of the metal disk and being coaxially attached to the bottom side of said metal disk.

6. The vibratory massage device as claimed in claim 5 further comprising a secondary enclosure having a cylindrical internal surface and a top edge portion, said top edge portion being attached to the internal face of the vibrating pad, and said internal surface being attached to the periphery of the metal disk.

7. The vibratory massage device as claimed in claim 6 wherein said secondary enclosure is a plastic ring.

8. The vibratory massage device as claimed in claim 6 wherein said secondary enclosure is a resonance box.

9. The vibratory massage device as claimed in claim 6 wherein said electronic control circuit comprises
a first electronic oscillator having an output and generating a primary electric wave with a frequency in a frequency range of 1-20 Hz;
a second electronic oscillator having an output, and an input connected to the output of said first electronic oscillator, and generating a secondary electric wave with a variable frequency in a frequency range of 250-350 Hz, said secondary electric wave being frequency modulated by the primary electric wave;
an amplifier having an output and an input, said amplifier input being connected to the output of said second electronic oscillator, and said amplifier output being connected to an electric input of the mechanical vibration element.

10. The vibratory massage device as claimed in claim 6 wherein said electronic control circuit comprises
an electronic random frequency pulse generator having an output and generating a primary electric pulse;
an electronic band-pass filter with a passing band of 250-350 Hz, having an output, and an input connected to the output of said electronic random frequency pulse generator, and generating a secondary electric pulse with a variable frequency in a frequency range of 250-350 Hz;
an amplifier having an output and an input, said amplifier input being connected to the output of said band-pass filter, and said amplifier output being connected to an electric input of the mechanical vibration element.

11. The vibratory massage device as claimed in claim 4 wherein said mechanical vibration element comprises
a rotating DC motor;
an eccentric load attached to the rotation axis of said DC motor; and
a secondary enclosure;
said DC motor being driven by the electronic control circuit and being attached to said secondary enclosure, and said enclosure being attached to the internal face of said vibrating pad.

12. A vibratory massage device comprising
a primary enclosure defining an enclosed volume and having an opening, said opening having a surface and an edge portion;
a vibrating pad having an internal face and an external face, and a surface slightly larger than the surface of the opening, said vibrating pad being positioned on top of said opening and overlapping the edge portion of said opening;
means for attaching the internal face of the vibrating pad to the primary enclosure in at least two points of the edge portion of the opening;
a piezoelectric transducer comprising a metal disk and a piezo-ceramic disk, said metal disk having a top side and a bottom side, said piezo-ceramic disk having a smaller diameter than the diameter of the metal disk and being coaxially attached to the bottom side of said metal disk;
a secondary enclosure having a cylindrical internal surface and a top edge portion, said top edge portion being attached to the internal face of the vibrating pad, and said internal surface being attached to the periphery of the metal disk; and
an electrical oscillator having an input and an output, said output being electrically connected to the piezoelectric transducer and providing said piezoelectric transducer with an oscillating electrical signal having a variable frequency in a frequency range of 250-350 Hz.

13. A method of vibration massage by stimulation of fast adapting mechano-receptors in a living body tissue, which comprises applying an acoustic vibration stimulation having a variable frequency in a frequency range of 250-350 Hz.

14. The method of vibration massage as claimed in claim 13, wherein the vibration stimulation is applied
(a) to a pain afflicted area of a body and
(b) to symmetrical areas of the body situated at a same height as the pain afflicted area, but on a contralateral side and on an opposite side of the body according to a sagittal and anterior-posterior symmetry.

15. A method of vibration massage as claimed in claim 14 wherein the vibration stimulation is applied tangentially to the pain afflicted area and the symmetrical areas.

16. A method of vibration massage as claimed in claim 14 wherein the vibration stimulation is applied perpendicularly to the pain afflicted area and the symmetrical areas.
